(19) United States
(12) Patent Application Publication
(10) Pub. No.: US 2013/0148389 A1
(43) Pub. Date: Jun. 13, 2013

(54) POWER CONVERSION DEVICE

(71) Applicant: Tetsuo Tanaka, Chiyoda-ku (JP)

(72) Inventor: Tetsuo Tanaka, Chiyoda-ku (JP)

(73) Assignee: MITSUBISHI ELECTRIC CORPORATION, Chiyoda-ku, Tokyo (JP)

(21) Appl. No.: 13/818,165

(22) PCT Filed: Aug. 24, 2010
(86) PCT No.: PCT/JP2010/064298

§ 371 Date: Feb. 21, 2013

(51) Int. Cl. H02M 5/458

(52) U.S. Cl. CPC H02M 5/458
USPC 363/37

(57) ABSTRACT

A light-emitting diode that is connected to be in a forward direction on a current path from a power potential side toward a signal output terminal side via a unidirectional photocoupler, at the time of being switched to a sink format; and a light-emitting diode that is connected to be in a forward direction on a current path from the signal output terminal side toward a common potential side via the unidirectional photocoupler, at the time of being switched to a source format are provided.

### FIELD

The present invention relates to a power conversion device, and more particularly to a method of visualizing an output state of a power conversion device.

### BACKGROUND

In an inverter, there is a method in which a light-emitting element is turned on or off corresponding to switching between a source format and a sink format so that it can be visibly recognized whether the inverter is operated in the source format or the sink format (Patent Literature 1).

Furthermore, there is a method in which, upon reception of an input signal from an external input signal source, the input signal is displayed in series with a photocoupler that sends the input signal to a programmable controller in one of two display modes according to the polarity of the input signal (Patent Literature 2).

### CITATION LIST

### Patent Literatures

Patent Literature 1: Japanese Patent Application Laid-open No. 2009-55656
Patent Literature 2: Japanese Utility Model Laid-open Publication No. 2-80809

### SUMMARY

### Technical Problem

However, in the method disclosed in Patent Literature 1, because the light-emitting element is connected in parallel with a sink/source switching circuit, an energization state cannot be displayed for each of signal input terminals or signal output terminals of the inverter.

In the method disclosed in Patent Literature 2, not only reverse current generated by switching between the source format and the sink format cannot be prevented, but an indicator lamp needs to be added separately, thereby complicating its circuit configuration.

The present invention has been achieved in view of the above problems, and an object of the present invention is to provide a power conversion device that can prevent reverse current generated by switching between a source format and a sink format and can display an energization state for each of signal input terminals or signal output terminals while suppressing complexity of a circuit configuration.

### Solution to Problem

In order to solve the aforementioned problems, a power conversion device according to one aspect of the present invention is configured to include: a sink/source switching circuit that switches an output of a signal from a signal output terminal to a sink format or a source format; a unidirectional photocoupler that transmits a signal to the signal output terminal; a first light-emitting diode that is connected to be in a forward direction on a current path from a power potential side toward the signal output terminal side via the unidirectional photocoupler at the time of being switched to the sink format; and a second light-emitting diode that is connected to be in a forward direction on a current path from the signal output terminal side toward a common potential side via the unidirectional photocoupler at the time of being switched to the source format.

### Advantageous Effects of Invention

According to the present invention, while suppressing complexity of the circuit configuration, reverse current generated by switching between a source format and a sink format can be prevented, and an energization state can be displayed for each of signal input terminals or signal output terminals.

### BRIEF DESCRIPTION OF DRAWINGS

FIG. 1 is a block diagram of a schematic configuration of a power conversion device according to a first embodiment of the present invention.

FIG. 2 is a circuit diagram of a configuration example of an output side of a control terminal block 6 shown in FIG. 1.

FIG. 3 is a circuit diagram of a configuration example on an input side of the control terminal block 6 shown in FIG. 1 at the time of connection by a sink format.

FIG. 4 is a circuit diagram of a configuration example on an input side of the control terminal block 6 shown in FIG. 1 at the time of connection by a source format.

FIG. 5(a) is a plan view of a schematic configuration of a power conversion device 2 shown in FIG. 1, and FIG. 5(b) is a side view of the schematic configuration of the power conversion device 2 shown in FIG. 1.

FIG. 6(a) is a plan view of a schematic configuration of the control terminal block 6 shown in FIG. 1, and FIG. 6(b) is a side view of the schematic configuration of the control terminal block 6 shown in FIG. 1.

FIG. 7 is a circuit diagram of a configuration example on an output side of the control terminal block 6 of a power conversion device according to a second embodiment of the present invention.

### DESCRIPTION OF EMBODIMENTS

Exemplary embodiments of a power conversion device according to the present invention will be explained below in detail with reference to the accompanying drawings. The present invention is not limited to the embodiments.

### First Embodiment

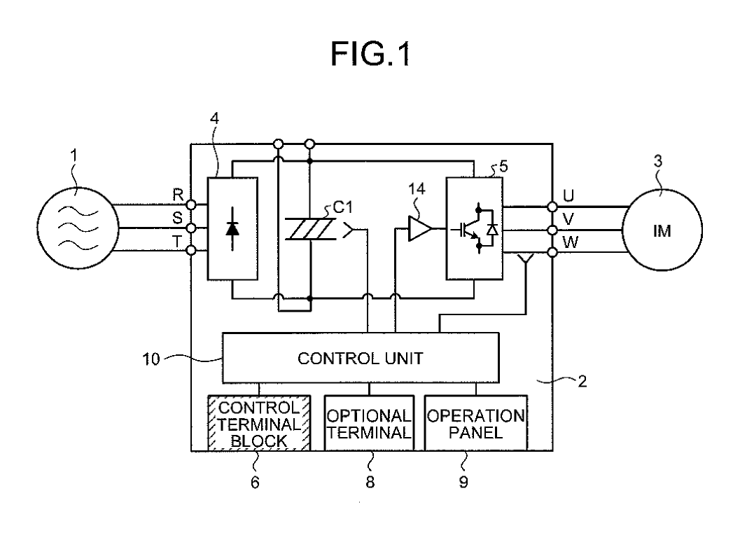

FIG. 1 is a block diagram of a schematic configuration of a power conversion device according to a first embodiment of the present invention. In FIG. 1, a power conversion device 2 includes a converter 4 that converts an alternating current of a commercial frequency to a direct current and an inverter 5 that converts a direct current to an alternating current of an intended frequency. On the converter 4 side, an R-phase input terminal R, an S-phase input terminal S, and a T-phase input terminal T are provided. On the inverter 5 side, a U-phase output terminal U, a V-phase output terminal V, and a W-phase output terminal W are provided. A smoothing capacitor C1 is connected to the subsequent stage of the converter 4.

The power conversion device 2 also includes a control unit 10 that executes PWM control of the inverter 5, a gate driver 14 that drives the inverter 5 based on a command from the control unit 10, a control terminal block 6 that inputs and outputs a signal for controlling the power conversion device 2 and a signal for monitoring the operating state of the power conversion device 2, an operation panel 9 for performing the operation of the power conversion device 2, and an optional terminal 8.

The converter 4 is connected to a three-phase power supply 1 via the R-phase input terminal R, the S-phase input terminal S, and the T-phase input terminal T, and the inverter 5 is connected to a motor 3 via the U-phase output terminal U, the V-phase output terminal V, and the W-phase output terminal W.

When an alternating current is input from the three-phase power supply 1 to the converter 4, the converter 4 converts the alternating current to a direct current and input the direct current to the inverter 5. The inverter 5 converts the direct current to an alternating current according to the PWM control by the control unit 10, and supplies the alternating current to the motor 3, thereby driving the motor 3.

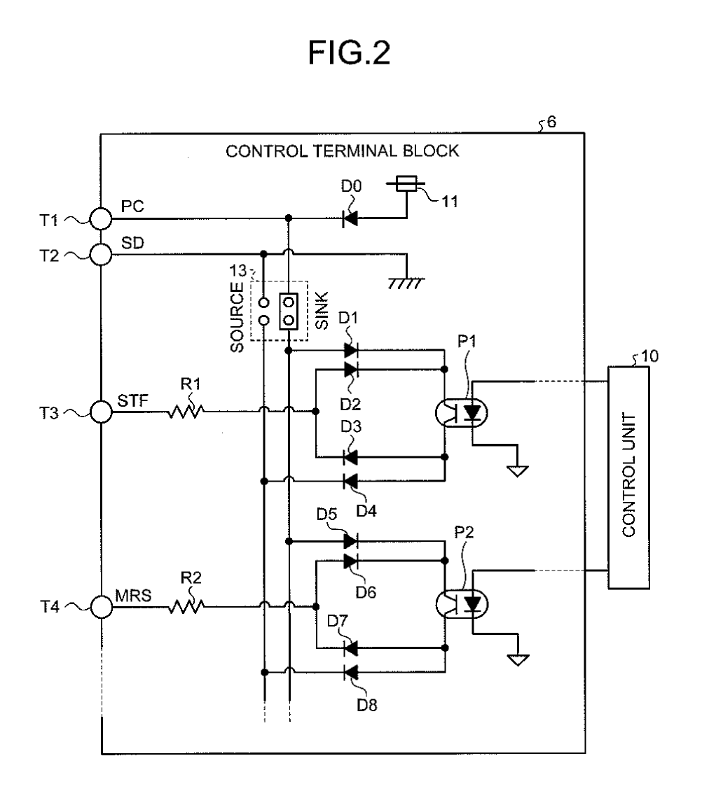

FIG. 2 is a circuit diagram of a configuration example of an output side of the control terminal block 6 shown in FIG. 1. In FIG. 2, a power terminal T1 that inputs a power potential, a common terminal T2 that inputs a common potential, and signal output terminals T3 and T4 that output signals are provided on the control terminal block 6. FIG. 2 is an example in which only two signal output terminals T3 and T4 are provided; however, the signal output terminals T3 and T4 can be provided in any arbitrary number.

As signals to be output from the signal output terminals T3 and T4, for example, a lower limit frequency signal, a low-speed detection signal, a designated-speed reach signal, a trip signal, and an overload detection signal can be mentioned.

A sink/source switching circuit 13, light-emitting diodes D1, D2, D5, and D6, backflow preventing diodes D3, D4, D7, and D8, and unidirectional photocouplers P1 and P2 are provided on the control terminal block 6.

A control power supply 11 is connected to the power terminal T1 via a rectifier diode D0. A ground potential is connected to the common terminal T2.

The power terminal T1 is connected also to anodes of the light-emitting diodes D1 and D5 via a sink pin of the sink/source switching circuit 13. The common terminal T2 is connected to cathodes of the backflow preventing diodes D4 and D8 via a source pin of the sink/source switching circuit 13.

Cathodes of the light-emitting diodes D1 and D2 are connected to a collector of a photo transistor of the unidirectional photocoupler P1. Anodes of the backflow preventing diodes D3 and D4 are connected to an emitter of the photo transistor of the unidirectional photocoupler P1.

Cathodes of the light-emitting diodes D5 and D6 are connected to a collector of a photo transistor of the unidirectional photocoupler P2. Anodes of the backflow preventing diodes D7 and D8 are connected to an emitter of the photo transistor of the unidirectional photocoupler P2.

The anode of the light-emitting diode D2 and the cathode of the backflow preventing diode D3 are connected to the signal output terminal T3 via a current-limiting resistor R1. The anode of the light-emitting diode D6 and the cathode of the backflow preventing diode D7 are connected to the signal output terminal T4 via a current-limiting resistor R2.

In the sink format, the power terminal T1 is connected to the anodes of the light-emitting diodes D1 and D5, and the common terminal T2 is disconnected from the backflow preventing diodes D4 and D8 by the sink/source switching circuit 13.

When a signal is sent from the control unit 10 to the unidirectional photocoupler P1, a current flows on a path from the power terminal T1→the sink/source switching circuit 13→the light-emitting diode D1→the unidirectional photocoupler P1→the backflow preventing diode D3→the current-limiting resistor R1→the signal output terminal T3, and the signal is output from the signal output terminal T3.

At this time, because an electric current flows in a forward direction to the light-emitting diode D1 on the current path from the power potential side toward the signal output terminal T3 side via the unidirectional photocoupler P1, the light-emitting diode D1 emits light, and the energization state of the signal output terminal T3 by the sink format is displayed. The light-emitting diode D2 and the backflow preventing diode D4 prevent the current from flowing backward.

When a signal is sent from the control unit 10 to the unidirectional photocoupler P2, an electric current flows on a path from the power terminal T1→the sink/source switching circuit 13→the light-emitting diode D5→the unidirectional photocoupler P2→the backflow preventing diode D7→the current-limiting resistor R2→the signal output terminal T4, and the signal is output from the signal output terminal T4.

At this time, because the current flows in a forward direction to the light-emitting diode D5 on a current path from the power potential side toward the signal output terminal T4 side via the unidirectional photocoupler P2, the light-emitting diode D5 emits light, and the energization state of the signal output terminal T4 by the sink format is displayed. The light-emitting diode D6 and the backflow preventing diode D8 prevent a current from flowing backward.

On the other hand, in the source format, the power terminal T1 is disconnected from the anodes of the light-emitting diodes D1 and D5, and the common terminal T2 is connected to the backflow preventing diodes D4 and D8 by the sink/source switching circuit 13.

When a signal is sent from the control unit 10 to the unidirectional photocoupler P1, an electric current flows on a path from the signal output terminal T3→the current-limiting resistor R1→the light-emitting diode D2→the unidirectional photocoupler P1→the backflow preventing diode D4→the sink/source switching circuit 13→the common terminal T2, and the signal is output from the signal output terminal T3.

At this time, because a current flows in a forward direction on the current path from the signal output terminal T3 side toward the common potential side via the unidirectional photocoupler P1, the light-emitting diode D2 emits light, and the energization state of the signal output terminal T3 by the source format is displayed. The light-emitting diode D1 and the backflow preventing diode D3 prevent the current from flowing backward.

When a signal is sent from the control unit 10 to the unidirectional photocoupler P2, a current flows on a path from the signal output terminal T4→the current-limiting resistor R2→the light-emitting diode D6→the unidirectional photocoupler P2→the backflow preventing diode D8→the sink/source switching circuit 13→the common terminal T2, and the signal is output from the signal output terminal T4.

At this time, because an electric current flows in a forward direction on the current path from the signal output terminal T4 side toward the common potential side via the unidirectional photocoupler P2, the light-emitting diode D6 emits light, and the energization state of the signal output terminal T4 by the source format is displayed. The light-emitting diode D5 and the backflow preventing diode D7 prevent the current from flowing backward.

Accordingly, the energization state can be displayed for each of the signal output terminals T3 and T4 by the light-emitting diodes D1, D2, D5, and D6, and reverse current generated by switching between the source format and the sink format can be prevented. Consequently, an indicator lamp does not need to be separately added in order to display the energization state for each of the signal output terminals T3 and T4, thereby enabling to suppress cost increase while suppressing complexity of the circuit configuration.

Furthermore, the energization state of the signal output terminals T3 and T4 does not need to be monitored by the control unit 10 in order to display the energization state for each of the signal output terminals T3 and T4, and the control unit 10 does not need to execute display control, thereby enabling to improve safety.

The light-emitting diodes D1, D2, D5, and D6 can respectively emit color light different from each other for each of the sink format and the source format. For example, the color light emitted from the light-emitting diodes D1 and D5 can be red, and the color light emitted from the light-emitting diodes D2 and D6 can be green.

In the example shown in FIG. 2, the method of using the light-emitting diodes D1, D2, D5, and D6 also as the backflow preventing diode has been explained. However, light-emitting diodes can be used for the backflow preventing diodes D3, D4, D7, and D8.

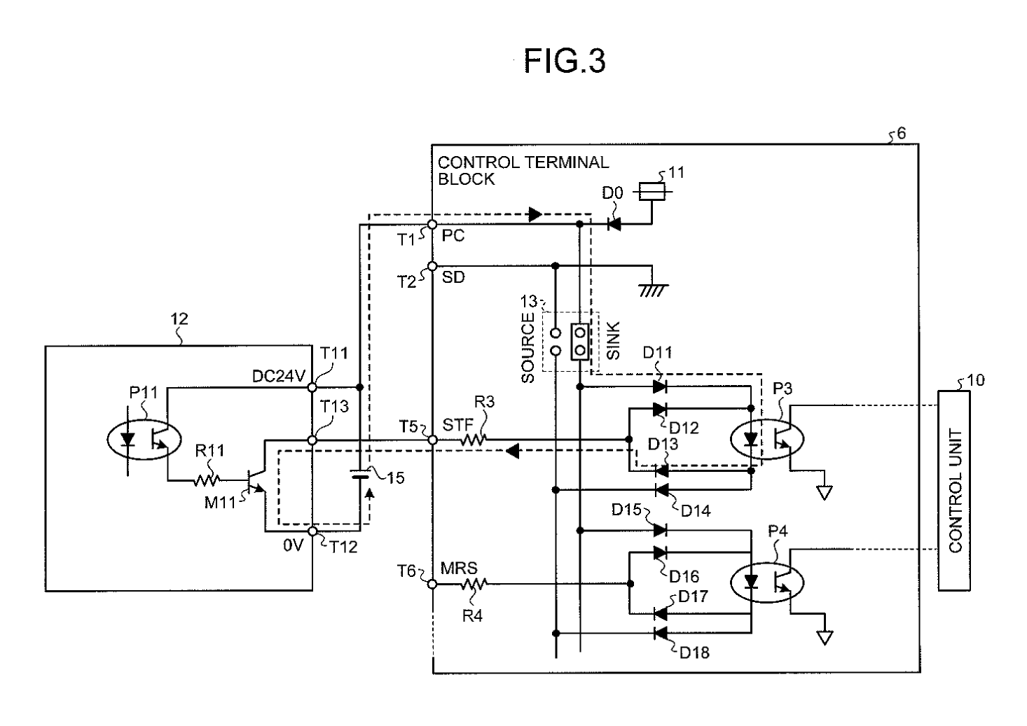

FIG. 3 is a circuit diagram of a configuration example on an input side of the control terminal block 6 shown in FIG. 1 at the time of connection by the sink format. In FIG. 3, the power terminal T1 that inputs power potential, the common terminal T2 that inputs common potential, and signal input terminals T5 and T6 that inputs signals are provided on the control terminal block 6. FIG. 3 is an example in which only two signal input terminals T5 and T6 are provided; however, the signal input terminals T5 and T6 can be provided in any arbitrary number.

As signals to be input to the signal input terminals T5 and T6, for example, a normal rotation/reverse rotation operation command, an operation preparation command, a multi-stage speed command, a DC braking command, and a reset command can be mentioned.

The sink/source switching circuit 13, light-emitting diodes D11, D12, D15, and D16, backflow preventing diodes D13, D14, D17, and D18, and unidirectional photocouplers P3 and P4 are also provided on the control terminal block 6.

The power terminal T1 is connected to anodes of the light-emitting diodes D11 and D15 via the sink pin of the sink/source switching circuit 13. The common terminal T2 is connected to cathodes of the backflow preventing diodes D14 and D18 via the source pin of the sink/source switching circuit 13.

Cathodes of the light-emitting diodes D11 and D12 are connected to the anode of a light-emitting diode of the unidirectional photocoupler P3. Anodes of the backflow preventing diodes D13 and D14 are connected to the cathode of the light-emitting diode of the unidirectional photocoupler P3.

Cathodes of the light-emitting diodes D15 and D16 are connected to the anode of a light-emitting diode of the unidirectional photocoupler P4. Anodes of the backflow preventing diodes D17 and D18 are connected to the cathode of the light-emitting diode of the unidirectional photocoupler P4.

The anode of the light-emitting diode D12 and the cathode of the backflow preventing diode D13 are connected to the signal input terminal T5 via a current-limiting resistor R3. The anode of the light-emitting diode D16 and the cathode of the backflow preventing diode D17 are connected to the signal input terminal T6 via a current-limiting resistor R4.

A resistor R11, a transistor M11, and an unidirectional photocoupler P11 are provided in a programmable controller 12.

The collector of a photo transistor of the unidirectional photocoupler P11 is connected to an external terminal T11, the emitter of the photo transistor of the unidirectional photocoupler P11 is connected to the base of the transistor M11 via the resistor R11.

The collector of the transistor M11 is connected to an external terminal T13, and the emitter of the transistor M11 is connected to an external terminal T12. An external power supply 15 is connected between the external terminals T11 and T12, and for example, a DC of 24 volts can be applied to the external terminal T11 and that of 0 volt can be provided to the external terminal T12.

In the sink format, the power terminal T1 is connected to the anodes of the light-emitting diodes D11 and D15, and the common terminal T2 is disconnected from the backflow preventing diodes D14 and D18 by the sink/source switching circuit 13. When a signal is input to the signal input terminal T5, the power terminal T1 is connected to the external terminal T11, and the signal input terminal T5 is connected to the external terminal T13.

When a signal is sent to the unidirectional photocoupler P11, the transistor M11 is turned on, and the signal is input to the signal input terminal T5 via the external terminal T13. When the signal is input to the signal input terminal T5, a current flows on a path from the power terminal T1→the sink/source switching circuit 13→the light-emitting diode D11→the unidirectional photocoupler P3→the backflow preventing diode D13→the current-limiting resistor R3→the signal input terminal T5.

At this time, because the current flows in a forward direction to the light-emitting diode D11 on a current path from the power potential side toward the signal input terminal T5 side via the unidirectional photocoupler P3, the light-emitting diode D11 emits light, and the energization state of the signal input terminal T5 by the sink format is displayed. The light-emitting diode D12 and the backflow preventing diode D14 prevent the current from flowing backward.

When a signal is input to the signal input terminal T6, a current flows on a path from the power terminal T1→the sink/source switching circuit 13→the light-emitting diode D15→the unidirectional photocoupler P4→the backflow preventing diode D17→the current-limiting resistor R4→the signal input terminal T6.

At this time, because the current flows in a forward direction to the light-emitting diode D15 on a current path from the power potential side toward the signal input terminal T6 side via the unidirectional photocoupler P4, the light-emitting diode D15 emits light, and the energization state of the signal input terminal T6 by the sink format is displayed. The light-emitting diode D16 and the backflow preventing diode D18 prevent the current from flowing backward.

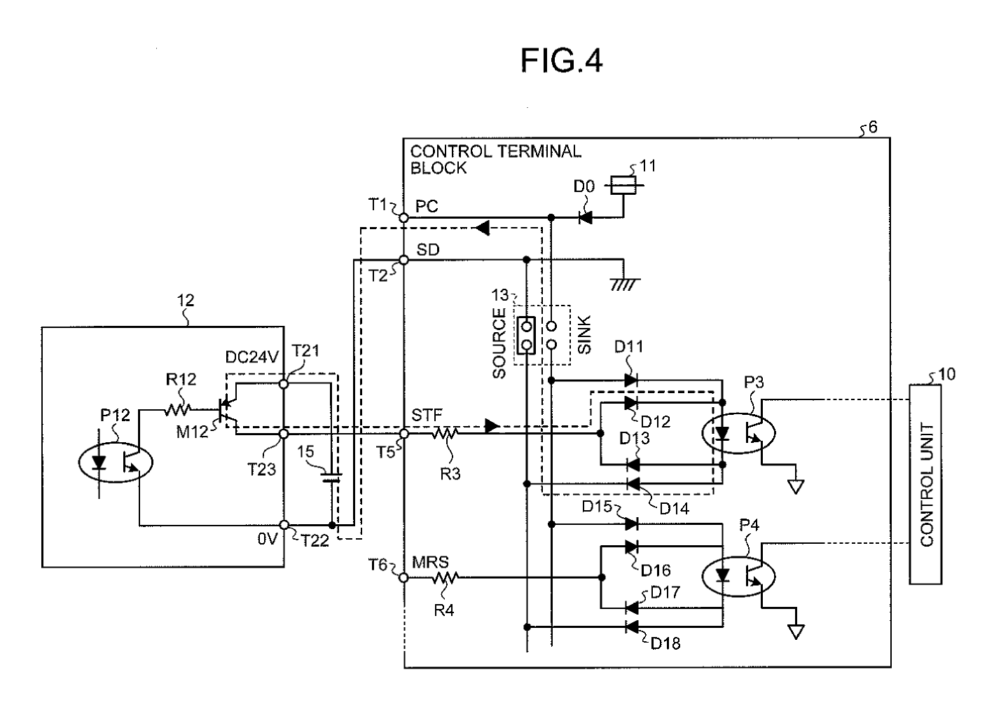

FIG. 4 is a circuit diagram of a configuration example on an input side of the control terminal block 6 shown in FIG. 1 at the time of connection by the source format. In FIG. 4, a resistor R12, a transistor M12, and a unidirectional photocoupler P12 are provided in the programmable controller 12.

The emitter of a photo transistor of the unidirectional photocoupler P12 is connected to an external terminal T22, and the collector of the photo transistor of the unidirectional photocoupler P12 is connected to the base of the transistor M12 via the resistor R12.

The collector of the transistor M12 is connected to an external terminal T23, and the emitter of the transistor M12 is connected to the external terminal T22. The external power supply 15 is connected between the external terminals T21 and T22, and for example, a DC of 24 volts can be applied to the external terminal T12 and that of 0 volt can be applied to the external terminal T22.

In the source format, the power terminal T1 is disconnected from the anodes of the light-emitting diodes D11 and D15, and the common terminal T2 is connected to the backflow preventing diodes D14 and D18 by the sink/source switching circuit 13. When a signal is input to the signal input terminal T5, the common terminal T2 is connected to the external terminal T22, and the signal input terminal T5 is connected to the external terminal T23.

When a signal is sent to the unidirectional photocoupler P12, the transistor M12 is turned on, and the signal is input to the signal input terminal T5 via the external terminal T23. When the signal is input to the signal input terminal T5, a current flows on a path from the signal input terminal T5→the current-limiting resistor R3→the light-emitting diode D12→the unidirectional photocoupler P3→the backflow preventing diode D14→the sink/source switching circuit 13→the common terminal T2.

At this time, because the current flows in a forward direction to the light-emitting diode D12 on a current path from the signal input terminal T5 side toward the common potential side via the unidirectional photocoupler P3, the light-emitting diode D12 emits light, and the energization state of the signal input terminal T5 by the source format is displayed. The light-emitting diode D11 and the backflow preventing diode D13 prevent the current from flowing backward.

When a signal is input to the signal input terminal T6, a current flows on a path from the signal input terminal T6→the current-limiting resistor R4→the light-emitting diode D16→the unidirectional photocoupler P4→the backflow preventing diode D18→the sink/source switching circuit 13→the common terminal T2.

At this time, because the current flows in a forward direction to the light-emitting diode D16 on a current path from the signal input terminal T6 side toward the common potential side via the unidirectional photocoupler P4, the light-emitting diode D16 emits light, and the energization state of the signal input terminal T6 by the source format is displayed. The light-emitting diode D15 and the backflow preventing diode D17 prevent the current from flowing backward.

Accordingly, the energization state can be displayed for each of the signal input terminals T5 and T6 by the light-emitting diodes D11, D12, D15, and D16, and reverse current generated by switching between the source format and the sink format can be prevented. Consequently, an indicator lamp does not need to be separately added in order to display the energization state for each of the signal input terminals T5 and T6, thereby enabling to suppress cost increase while suppressing complexity of the circuit configuration.

Furthermore, the energization state of the signal input terminals T5 and T6 does not need to be monitored by the control unit 10 in order to display the energization state for each of the signal input terminals T5 and T6, and the control unit 10 does not need to execute display control, thereby enabling to improve safety.

The light-emitting diodes D11, D12, D15, and D16 can be arranged such that they respectively emit color light different from each other for each of the sink format and the source format. For example, the color light emitted from the light-emitting diodes D11 and D15 can be red, and the color light emitted from the light-emitting diodes D12 and D16 can be green.

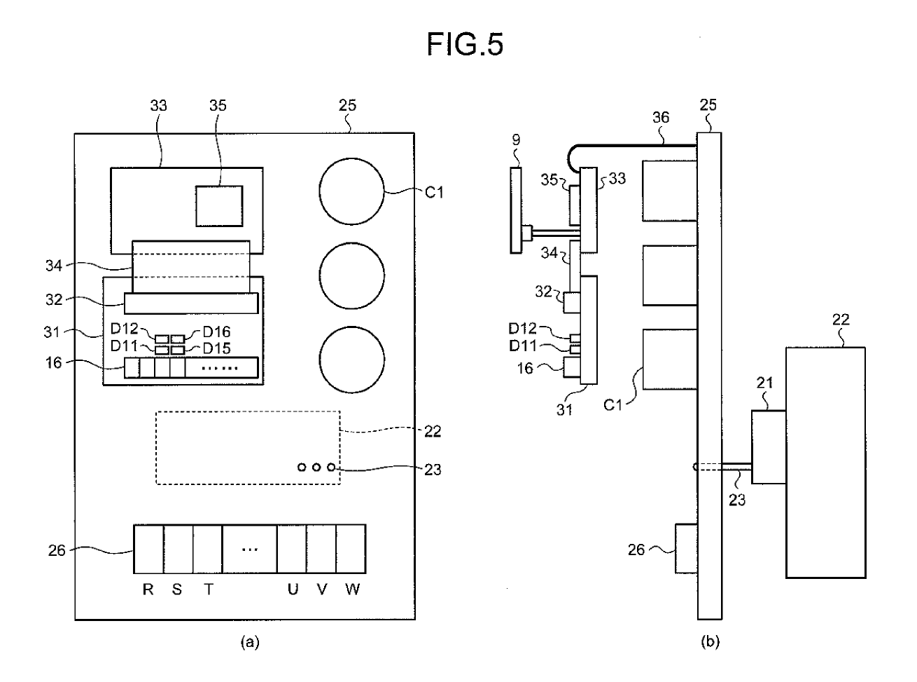

FIG. 5(a) is a plan view of a schematic configuration of the power conversion device 2 shown in FIG. 1, and FIG. 5(b) is a side view of the schematic configuration of the power conversion device 2 shown in FIG. 1. In FIG. 5, a semiconductor module 21 is mounted on a main circuit board 25, and is electrically connected thereto via a module pin 23. Semiconductor chips constituting the converter 4 and the inverter 5 can be incorporated in the semiconductor module 21.

On the rear surface of the semiconductor module 21, a heat sink 22 that discharges heat generated from the semiconductor module 21 is arranged. The module pin 23 has been pulled out from the front surface of the semiconductor module 21.

The smoothing capacitor C1 and a main-circuit terminal block 26 are mounted on the main circuit board 25. The R-phase input terminal R, the S-phase input terminal S, the T-phase input terminal T, the U-phase output terminal U, the V-phase output terminal V, and the W-phase output terminal W can be provided on the main-circuit terminal block 26.

A control-terminal-block board 31 and a control board 33 are provided on the main circuit board 25. The control-terminal-block board 31 and the control board 33 are connected to each other via connectors 32 and 34.

A control-terminal-block main body 16 and the light-emitting diodes D11, D12, D15, and D16 are mounted on the control-terminal-block board 31. The control-terminal-block board 31 and the control-terminal-block main body 16 can constitute the control terminal block 6 shown in FIG. 1.

A microcomputer 35 is mounted on the control board 33. The control board 33 and the microcomputer 35 can constitute the control unit 10 shown in FIG. 1. The control board 33 is electrically connected to the main circuit board 25 via a cable 36.

The operation panel 9 is arranged on the control board 33. The operation panel 9 can send various operation commands of the power conversion device 2 to the control unit 10 and can display operation information sent from the control unit 10. The operation panel 9 is constituted to be detachable from the control board 33.

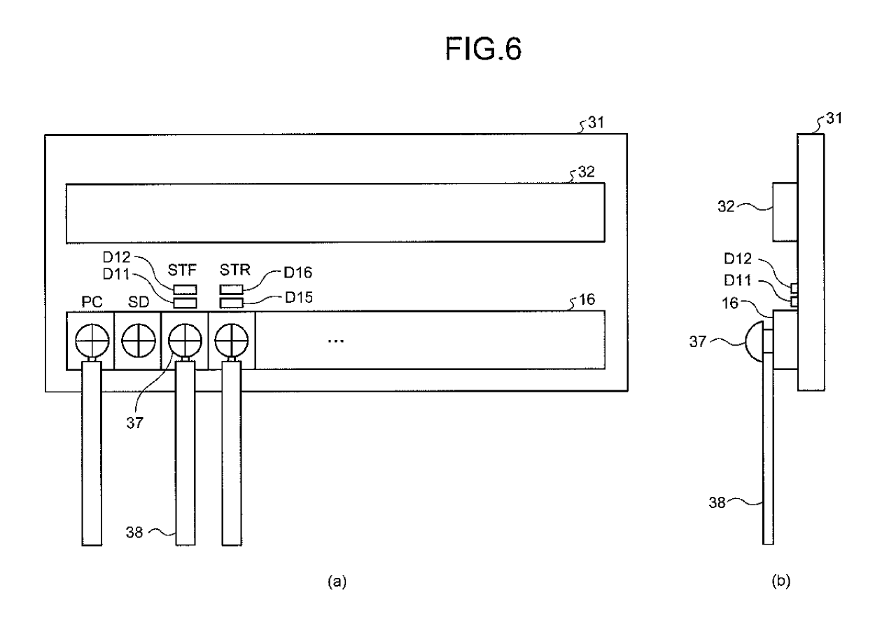

FIG. 6(a) is a plan view of a schematic configuration of the control terminal block 6 shown in FIG. 1, and FIG. 6(b) is a side view of the schematic configuration of the control terminal block 6 shown in FIG. 1. In FIG. 6, the power terminal T1, the common terminal T2, the signal output terminals T3 and T4 shown in FIG. 2 and the signal input terminals T5 and T6 shown in FIG. 3 are provided on the control-terminal-block main body 16.

A control signal line 38 is fixed by a screw 37 to the power terminal T1, the common terminal T2, the signal output terminals T3 and T4, and the signal input terminals T5 and T6 shown in FIG. 3 on the control-terminal-block main body 16.

The light-emitting diodes D11 and D12 are arranged to be adjacent to the signal input terminal T5 on the control-terminal-block main body 16, and the light-emitting diodes D15 and D16 are arranged to be adjacent to the signal input terminal T6 on the control-terminal-block main body 16.

Accordingly, by checking light-emitting states of the light-emitting diodes D11, D12, D15, and D16, it can be easily determined which of the signal input terminals T5 and T6 is in the energization state, thereby enabling to improve the visibility of the energization states of the respective signal input terminals T5 and T6.

Furthermore, by mounting the light-emitting diodes D11, D12, D15, and D16 on the control-terminal-block board 31, even if the operation panel 9 is detached, the energization states of the signal input terminals T5 and T6 can be checked, thereby enabling to improve the safety.

### Second Embodiment

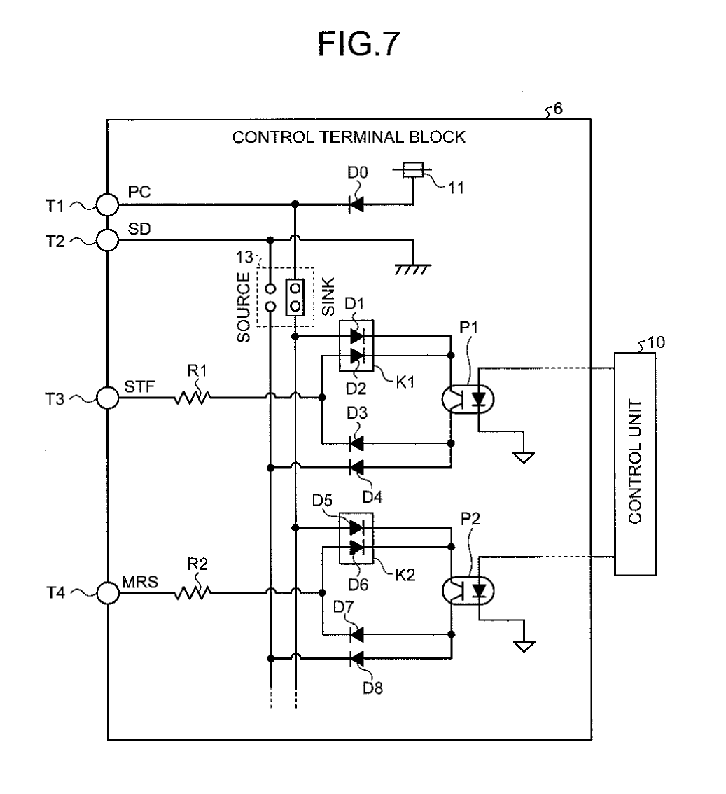

FIG. 7 is a circuit diagram of a configuration example on the output side of the control terminal block 6 of a power conversion device according to a second embodiment of the present invention. In FIG. 7, the circuit configuration of the control terminal block 6 is same as that of the control terminal block 6 shown in FIG. 2. However, in the control terminal block 6 shown in FIG. 7, the light-emitting diodes D1 and D2 are accommodated in one package K1, thereby forming a packaged structure. In addition, the light-emitting diodes D5 and D6 are accommodated in one package K2, thereby forming a packaged structure.

With this configuration, as compared to a method of individually packaging the light-emitting diodes D1, D2, D5, and D6, the unit price of the light-emitting diodes D1, D2, D5, and D6 can be reduced, thereby achieving cost reduction.

### INDUSTRIAL APPLICABILITY

As described above, the power conversion device according to the present invention can prevent reverse current generated by switching between a source format and a sink format and can display an energization state for each of signal input terminals or signal output terminals while suppressing complexity of a circuit configuration, and the power conversion device is suitable for a method of visualizing an energization state of a terminal of a control terminal block of the power conversion device.

### REFERENCE SIGNS LIST

1 three-phase power supply
2 power conversion device
3 motor
4 converter
inverter
6 control terminal block
8 optional terminal
9 operation panel
10 control unit
C1 smoothing capacitor
R R-phase input terminal
S S-phase input terminal
T T-phase input terminal
U U-phase output terminal
V-phase output terminal
W W-phase output terminal
11 control power supply
12 programmable controller
13 sink/source switching circuit
14 gate driver
15 external power supply
16 control-terminal-block main body
T1 power terminal
T2 common terminal
T3, T4 signal output terminal
T5, T6 signal input terminal
T11 to T13, T21 to T23 external terminal
D0 rectifier diode
D1, D2, D5, D6, D11, D12, D15, D16 light-emitting diode
D3, D4, D7, D8, D13, D14, D17, D18 backflow preventing diode
P1 to P4, P11, P12 unidirectional photocoupler
R1 to R4 current-limiting resistor
R11, R12 resistor
M11, M12 transistor
21 semiconductor module
22 heat sink
23 module pin
25 main circuit board
26 main-circuit terminal block
31 control-terminal-block board
32, 34 connector
33 control board
35 microcomputer
36 cable
37 screw
38 control signal line
K1, K2 package

1-8. (canceled)

9. A power conversion device comprising:
a sink/source switching circuit that switches an output of a signal from a signal output terminal to a sink format or a source format;
a unidirectional photocoupler that transmits a signal to the signal output terminal;
a first light-emitting diode that is connected to be in a forward direction on a current path from a power potential side toward the signal output terminal side via the unidirectional photocoupler at the time of being switched to the sink format, and prevents reverse current of the unidirectional photocoupler at a time of being switched to the source format; and
a second light-emitting diode that is connected to be in a forward direction on a current path from the signal output terminal side toward a common potential side via the unidirectional photocoupler at the time of being switched to the source format, and prevents reverse current of the unidirectional photocoupler at the time of being switched to the sink format.

10. The power conversion device according to claim 9, wherein the first light-emitting diode and the second light-emitting diode are formed in an all-in-one package.

11. The power conversion device according to claim 9, wherein the first light-emitting diode and the second light-emitting diode respectively emit color light different from each other.

12. The power conversion device according to claim 9, wherein the first light-emitting diode and the second light-emitting diode are mounted on a control terminal block, and are arranged to be adjacent to the signal output terminal of the control terminal block.

13. A power conversion device comprising:
a sink/source switching circuit that switches an input of a signal from a signal input terminal to a sink format or a source format;
a unidirectional photocoupler that transmits a signal from the signal input terminal;
a first light-emitting diode that is connected to be in a forward direction on a current path from a power potential side toward the signal input terminal side via the unidirectional photocoupler at the time of being switched to the sink format, and prevents reverse current of the unidirectional photocoupler at a time of being switched to the source format; and
a second light-emitting diode that is connected to be in a forward direction on a current path from the signal input terminal side toward a common potential side via the unidirectional photocoupler at the time of being switched to the source format, and prevents reverse current of the unidirectional photocoupler at the time of being switched to the sink format.

14. The power conversion device according to claim 13, wherein the first light-emitting diode and the second light-emitting diode are formed in an all-in-one package.

15. The power conversion device according to claim 13, wherein the first light-emitting diode and the second light-emitting diode respectively emit color light different from each other.

16. The power conversion device according to claim 13, wherein the first light-emitting diode and the second light-emitting diode are mounted on a control terminal block, and are arranged to be adjacent to the signal input terminal of the control terminal block.
